(19) United States
(12) Patent Application Publication
(10) Pub. No.: US 2011/0105829 A1
(43) Pub. Date: May 5, 2011

(54) Implantable Signal Delivery Systems

(75) Inventor: Geoffrey R. Ball, Axams (AT)

(73) Assignee: VIBRANT MED-EL HEARING TECHNOLOGY GMBH, Innsbruck (AT)

(21) Appl. No.: 12/914,046

(22) Filed: Oct. 28, 2010

Related U.S. Application Data
(60) Provisional application No. 61/256,371, filed on Oct. 30, 2009.
(60) Provisional application No. 61/310,742, filed on Mar. 5, 2010.
(60) Provisional application No. 61/319,504, filed on Mar. 31, 2010.

(51) Int. Cl. H04R 25/00

(52) U.S. Cl. 600/25

(57) ABSTRACT

An implantable hearing prosthesis is described for a recipient patient. An implantable receiving coil receives an externally generated communication data signal. An implantable signal processor is in communication with the receiving coil for converting the communication data signal into a transducer stimulation signal. An implantable enclosed acoustic transducer is in communication with the signal processor for converting the transducer stimulation signal into an acoustic signal for generating acoustic vibrational stimulation of one or more hearing structures in the middle ear of the patient. The transducer can be enclosed in an implantable signal delivery baffle. A probe microphone system includes a baffle to seal middle ear structures to reduce ambient noise pickup.

This application claims priority from U.S. Provisional Patent Application 61/256,371, filed Oct. 30, 2009; U.S. Provisional Patent Application 61/310,742, filed Mar. 5, 2010; and U.S. Provisional Patent Application 61/319,504, filed Mar. 31, 2010; which are incorporated herein by reference.

### FIELD OF THE INVENTION

The present invention relates to medical implants, and more specifically to a novel transcutaneous auditory prosthetic implant system.

### BACKGROUND ART

A normal ear transmits sounds as shown in FIG. 1 through the outer ear 101 to the tympanic membrane 102, which moves the ossicles of the middle ear 103 that vibrate the oval window 106 and round window 107 membranes of the cochlea 104. The cochlea 104 is a long narrow duct wound spirally about its axis for approximately two and a half turns. It includes an upper channel known as the scala vestibuli and a lower channel known as the scala tympani, which are connected by the cochlear duct. The cochlea 104 forms an upright spiraling cone with a center called the modiolar where the spiral ganglion cells of the cochlear nerve 105 reside. In response to received sounds transmitted by the middle ear 103, the fluid-filled cochlea 104 functions as a transducer to generate electric pulses which are transmitted to the cochlear nerve 105, and ultimately to the brain.

Hearing is impaired when there are problems in the ability to transduce external sounds into meaningful action potentials along the neural substrate of the cochlea 104. To improve impaired hearing, auditory prostheses have been developed. For example, when the impairment is related to operation of the middle ear 103, a conventional hearing aid or middle ear implant may be used to provide acoustic-mechanical stimulation to the auditory system in the form of amplified sound. Or when the impairment is associated with the cochlea 104, a cochlear implant with an implanted stimulation electrode can electrically stimulate auditory nerve tissue with small currents delivered by multiple electrode contacts distributed along the electrode.

Middle ear implants employ electromagnetic transducers to convert sounds into mechanical vibration of the middle ear 103. A coil winding is held stationary by attachment to a non-vibrating structure within the middle ear 103 and microphone signal current is delivered to the coil winding to generate an electromagnetic field. A magnet is attached to an ossicle within the middle ear 103 so that the magnetic field of the magnet interacts with the magnetic field of the coil. The magnet vibrates in response to the interaction of the magnetic fields, causing vibration of the bones of the middle ear 103. See U.S. Pat. No. 6,190,305, which is incorporated herein by reference.

### SUMMARY OF THE INVENTION

Embodiments of the present invention are directed to an implantable hearing prosthesis for a recipient patient. An implantable receiving coil receives an externally generated communication data signal. An implantable signal processor is in communication with the receiving coil for converting the communication data signal into a transducer stimulation signal. An implantable enclosed acoustic transducer is in communication with the signal processor for converting the transducer stimulation signal into an acoustic signal for generating acoustic vibrational stimulation of one or more hearing structures in the middle ear of the patient. As used herein, the term “acoustic” refers to the propagation of sound through air, as distinguished from mechanical vibration in solid materials.

In further embodiments, the acoustic transducer may specifically be a floating mass transducer. The acoustic transducer may be adapted to float in an operating position without direct attachment to the tympanic membrane or skull bone of the patient, for example, at the end of a tethering lead. Or, the acoustic transducer may be adapted to be fixedly attached, for example to skull bone or to the tympanic membrane.

The acoustic transducer may have a flexible body for generating the acoustic signal. In specific embodiments, the acoustic transducer may be hermetically enclosed or enclosed by a biocompatible membrane.

In specific embodiments, the acoustic transducer may produce a uni-directional acoustic signal or a multi-directional (e.g., bi-directional) acoustic signal. The hearing structures may include the oval window membrane, the round window membrane, and/or one or more ossicles in the middle ear of the patient.

In various embodiments of the invention, an implantable signal delivery baffle is provided to direct acoustical and/or mechanical energy to structures in an ear. The signal delivery baffle contains an implantable enclosed transducer. The baffle may be an open-ended cylinder with a series of folds in the baffle's wall. The structure and composition of the baffle effectively couples acoustic or mechanical energy generated by the transducer to selected ear structures and isolates residual energy from causing high reverse transfer function (“RTF”) levels. The baffle can be tailored to fit the anatomy of the ear. In specific embodiments, the baffle is made of silicone or of titanium and includes a series of folds in the baffle's wall to determine modes of energy propagation. The folds may be aligned perpendicular or parallel to the longitudinal axis of the cylinder or may be twisted about the longitudinal axis of the cylinder.

In other embodiments of the present invention, a probe microphone system is provided that can substantially mitigate problems with sound instrumentation presented by ambient noise in environments, such as operating rooms. A calibrated sound stimulation signal is fed to a transducer that generates acoustic and/or mechanical energy in the middle ear. A disposable baffle is provided that encloses and seals a volume in the middle ear such as a cochlear window or the entire middle ear. A microphone tube conducts sound from the baffle chamber to a microphone. The microphone records sound pressure levels generating an electrical signal that is amplified and fed to an analog-to-digital converter. The output of the converter is read by processing means, such as a computer and compared to expected sound levels. The microphone baffle serves to substantially reduce ambient noise levels, thus allowing accurate measurements.

### BRIEF DESCRIPTION OF THE DRAWINGS

FIG. 1 shows anatomical structures of a typical human ear.

FIG. 2 shows an example of one specific embodiment of the present invention as implanted in the ear of a recipient patient.

FIG. 3 shows further details of an acoustic transducer according to one embodiment of the present invention.

FIGS. 4A, B and C show an implantable delivery baffle of silicone including a transducer, according to an embodiment of the invention.

FIGS. 5A through 5C show an implantable delivery baffle of titanium including a transducer according to an embodiment of the invention.

FIG. 6 is a diagram of a probe microphone system with a disposable baffle according to an embodiment of the invention.

FIG. 7 shows further details of the baffle of the probe microphone system of FIG. 6.

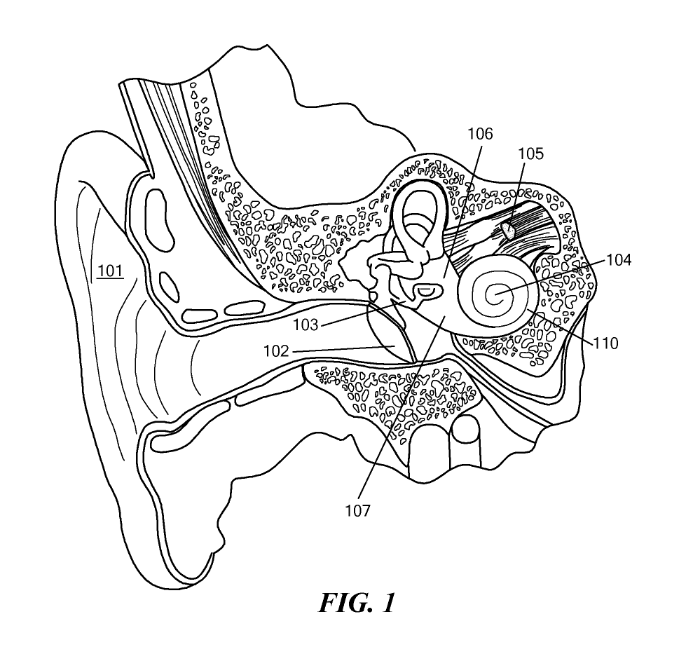

### DETAILED DESCRIPTION OF SPECIFIC EMBODIMENTS

Various embodiments of the present invention are directed to an implantable hearing prosthesis for a recipient patient using an implantable enclosed acoustic transducer. This directs the acoustic sound signal as vibrational energy closer to the target structure for hearing, the cochlea.

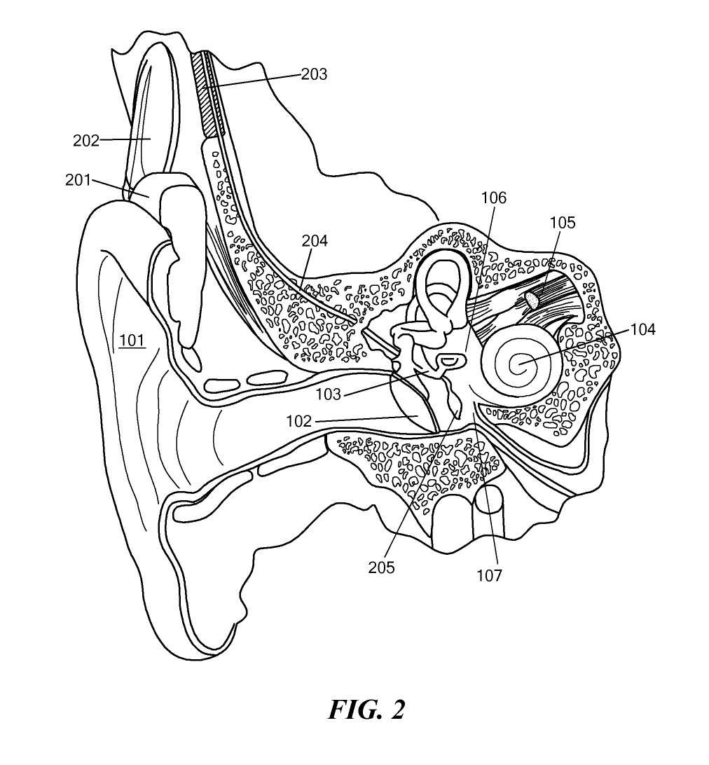

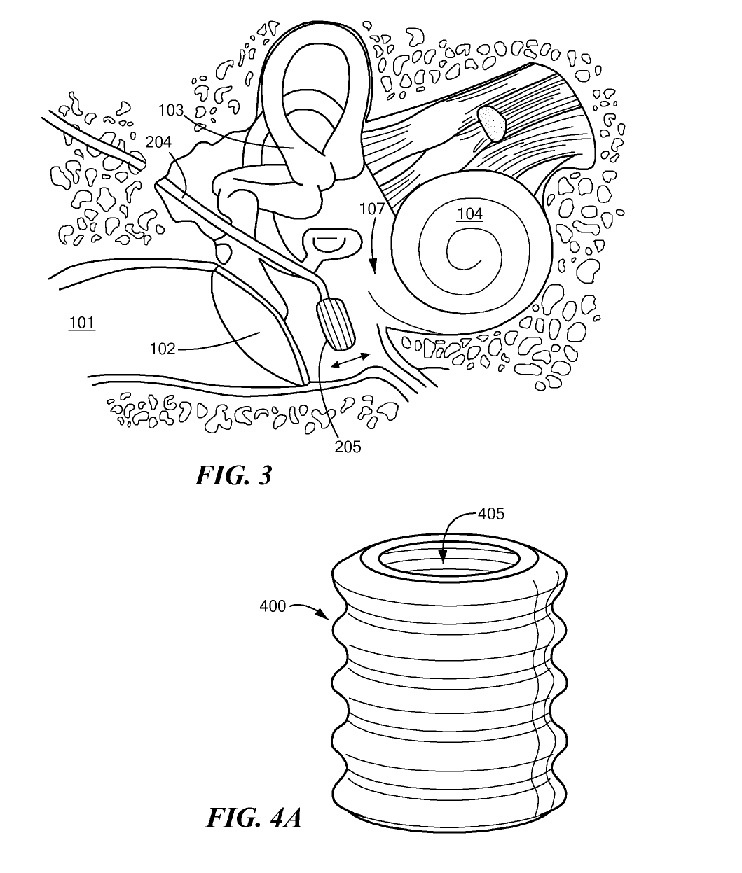

FIG. 2 shows an example of one specific embodiment of the present invention as implanted in the ear of a recipient patient, and FIG. 3 shows further details of such an acoustic transducer. An external signal processor 201 generates a communication data signal representing nearby sounds. An external transmitting coil 202 is placed on the surface of the patient's skin over a corresponding receiving coil 203 that is implanted just under the skin. The transmitting coil 202 couples the communication data signal through the skin to the implanted receiving coil 203. An implantable signal processor is in communication with the receiving coil 203 (e.g., in a shared housing) and converts the communication data signal into a transducer stimulation signal. The transducer stimulation signal from the implantable signal processor is coupled by an implant lead 204 to an implantable enclosed acoustic transducer 205 which is positioned near the hearing structures of the middle ear 103 and cochlea 104 such as the round window 107 and/or oval window 106 membranes. The acoustic transducer 205 converts the transducer stimulation signal from the implant lead 204 into a corresponding acoustic signal for generating acoustic vibrational stimulation of one or more of the nearby hearing structures in the middle ear 103 and/or cochlea 104.

In the embodiment shown in FIGS. 2 and 3, the acoustic transducer 205 floats at the tethering end of the implant lead 204 in its operating position near the hearing structures in the middle ear 103 and/or cochlea 104 without direct attachment to the tympanic membrane 102 or skull bone of the patient. In such embodiments, the acoustic transducer may produce a multi-directional (e.g., bi-directional) acoustic signal that can vibrationally stimulate multiple target hearing structures—e.g., one or more of the ossicles in the middle ear 103, the round window 107, and/or oval window 106 of the cochlea 104.

In other embodiments, though, the acoustic transducer 205 may be adapted to be fixedly attached, for example to skull bone or to the tympanic membrane 102. In such embodiments, the acoustic transducer 205 may produce what is in effect a uni-directional acoustic signal which may vibrationally stimulate just a single hearing structure, or multiple target hearing structures.

The acoustic transducer 205 may specifically be a floating mass transducer, FMT, with a flexible body for generating the acoustic signal. In some embodiments, the acoustic transducer 205 may be hermetically enclosed or enclosed by a biocompatible membrane (e.g., acting as an implantable acoustic speaker).

### Implantable Signal Delivery Baffle

In preferred embodiments of the invention, an implantable signal delivery baffle is provided to direct acoustical and/or mechanical energy to structures in an ear. The baffle may be an open-ended cylinder with a series of folds in the baffle's wall. The baffle contains an implantable enclosed transducer. The structure and composition of the baffle effectively couples acoustic or mechanical energy generated by the transducer to selected middle ear structures and isolates residual energy from causing high reverse transfer function (“RTF”) levels. The baffle can be tailored to fit the anatomy of the ear.

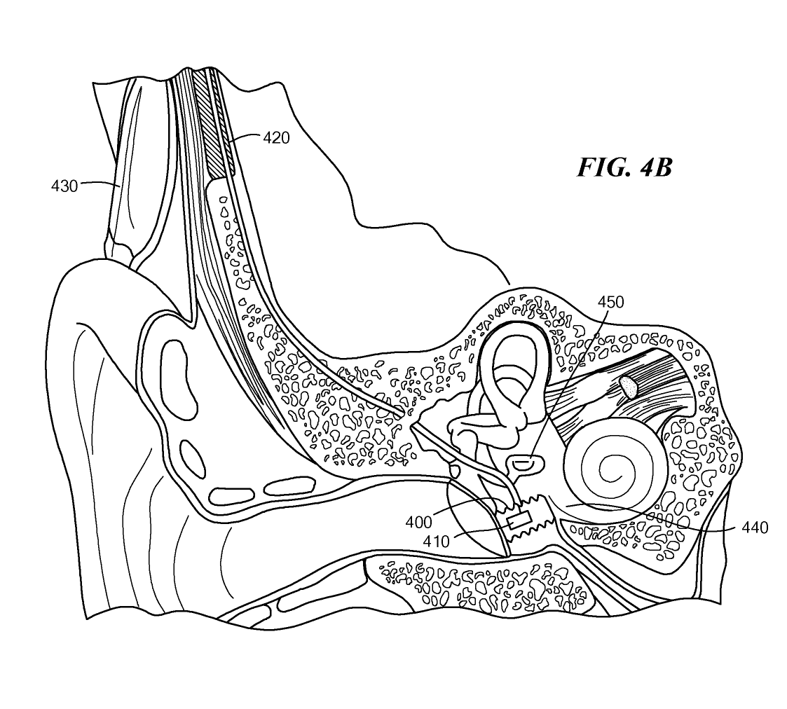

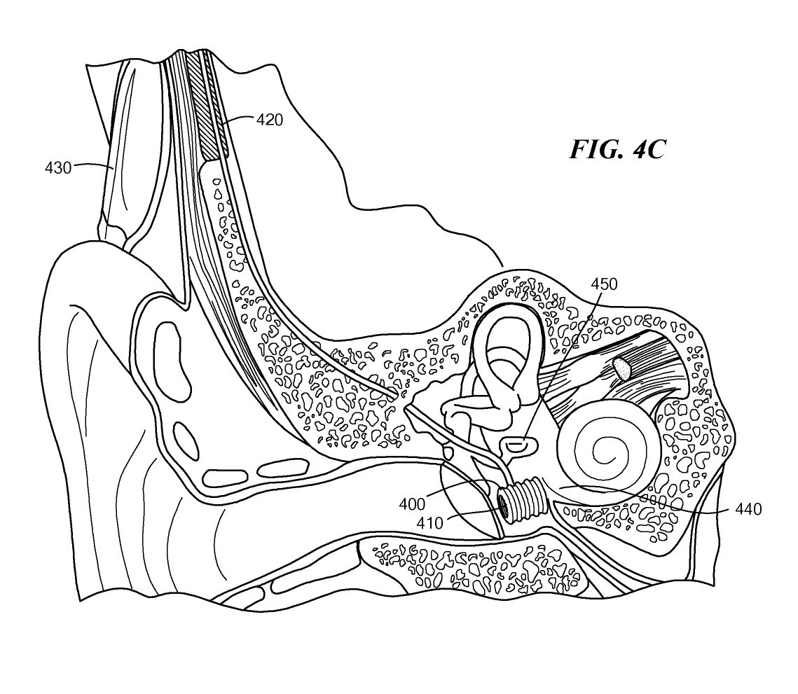

FIG. 4A shows one embodiment of a signal delivery baffle 400. The baffle 400 is a cylinder of flexible silicone with an open end 405. The accordion-like folds in the wall of the baffle 400 help determine the mode of acoustic or mechanical energy transfer to ear structures. The accordion-like folds of the baffle 400 also allow the surgeon to adjust (“squish”) the baffle 400 to fit the anatomy of the patient. The surgeon can compress the baffle 400 along its longitudinal axis or trim the baffle 400 perpendicular to this axis. FIG. 4B shows the baffle 400 of FIG. 4A in cross section installed in an ear. Transducer 410 is stimulated with a signal from a receiver 420. The signal is transmitted by an external transmitter 430. The baffle 400 is positioned adjacent to the round window 440 of the middle ear in this example. FIG. 4C shows the baffle 400 similarly positioned on the round window 440 and shows other middle ear structures 450. Of course, the baffle 400 can be positioned to direct energy to various ear structures.

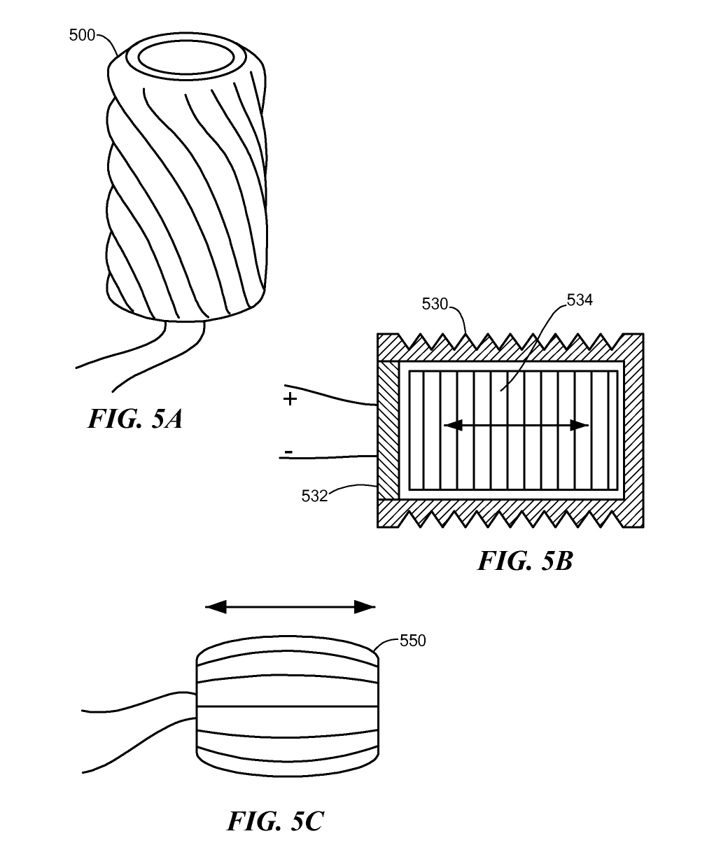

FIG. 5A shows an implantable signal delivery baffle 500 according to another embodiment of the invention. The baffle 500 is made of titanium and formed as an open-ended cylinder. The diameter of the baffle 500 in preferred embodiments can range from about 1 to about 4 mm with the length of the baffle 500 likewise ranging from about 1 to about 4 mm. The folds in the wall of the baffle 500 of FIG. 5A twist about the longitudinal axis of the cylinder. The twisted baffle couples energy with a primary mode along the twisted ribs of the baffle 500 while a secondary mode is aligned along the longitudinal axis of the baffle 500. FIG. 5B shows a further embodiment of a titanium baffle 530 in cross section. The baffle 530 encloses a piezoelectric dual action transducer 534. The cylinder has a welded end cap 532 of titanium. Further energy coupling modes of the ribbed baffle 530 design are also shown. FIG. 5C shows a further titanium baffle 550 with folds in the form of ribs that run parallel to the longitudinal axis of the baffle cylinder. The primary mode of energy delivery for this baffle 550 is parallel to the longitudinal axis of the baffle.

Probe Microphone with Disposable Baffle

In preferred embodiments of the present invention, a probe microphone system is provided that can substantially mitigate problems for sound instrumentation that are presented by high ambient noise levels in operating rooms. A calibrated sound stimulation signal is fed to a transducer that generates sound in an ear. A disposable baffle is provided that seals a window of the ear or the entire middle ear. A microphone tube conducts sound from the baffle chamber to a microphone. The microphone records sound pressure levels generating an electrical signal that is amplified and fed to an analog-to-digital converter. The output of the converter is read by processing means, such as a computer and compared to expected sound levels. The baffle serves to substantially reduce ambient noise levels, thus allowing accurate measurements.

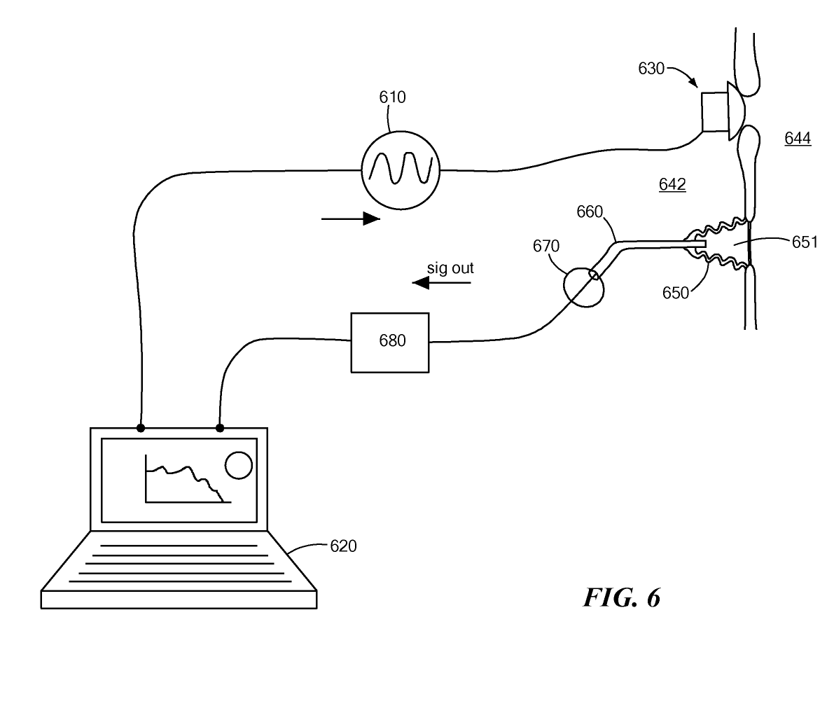

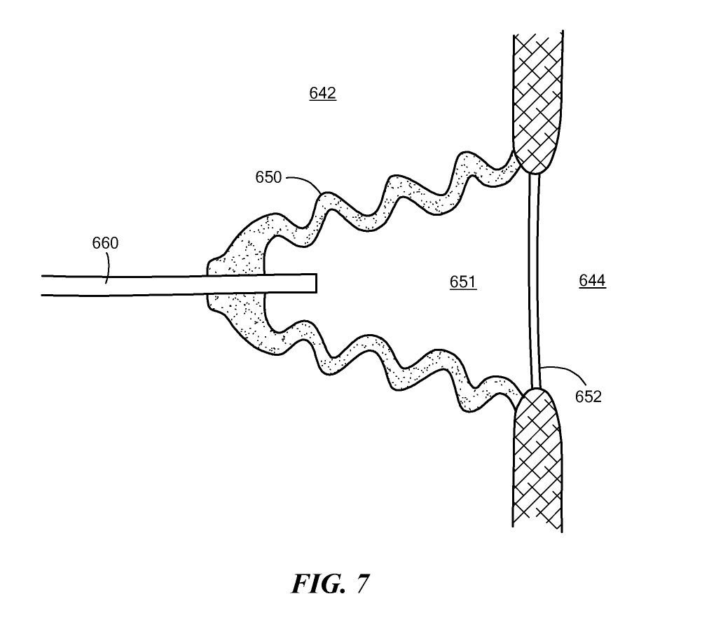

FIGS. 6 and 7 show a probe microphone system according to another embodiment of the invention. A sound generator 610, which may be driven by a computer 620, generates a calibrated signal to drive transducer 630. The transducer delivers sound energy to vibratory structures of the middle ear 642. The transducer may be a floating mass transducer or other transducer as known in the art. A microphone baffle 650 in the middle ear 642 encloses a volume therein including the ear structure to be probed, such as a cochlear window 652 in this example, forming a sound chamber 651. The baffle wall substantially attenuates the ambient noise that reaches the sound chamber 651. A microphone tube 660 conducts sound from the baffle chamber to a microphone 670. The microphone 670 records sound pressure levels and generates an electrical signal that is amplified 680 and fed to an analog-to-digital converter (not-shown). The output of the converter is read by processing means, such as a computer 620, and compared to expected sound levels. The microphone baffle 650 serves to substantially reduce ambient noise levels at the recording microphone 670, thus facilitating accurate sound measurement.

In various embodiments of the probe microphone system, the baffle 650 may be made of soft, medical grade silicone that seals a window of the ear 652 or the entire middle ear. Other embodiments may employ other materials for the baffle. These baffles may be disposable or reusable. The microphone probe tubes 660 are sterile and may be disposable or reusable.

Although various exemplary embodiments of the invention have been disclosed, it should be apparent to those skilled in the art that various changes and modifications can be made which will achieve some of the advantages of the invention without departing from the true scope of the invention.

What is claimed is:

1. An implantable hearing prosthesis for a recipient patient, the prosthesis comprising:
an implantable receiving coil for receiving an externally generated communication data signal;
an implantable signal processor in communication with the receiving coil for converting the communication data signal into a transducer stimulation signal; and
an implantable enclosed acoustic transducer in communication with the signal processor for converting the transducer stimulation signal into an acoustic signal for generating acoustic vibrational stimulation of one or more hearing structures in the middle ear of the patient.

2. An implantable hearing prosthesis according to claim 1, wherein the acoustic transducer is a floating mass transducer.

3. An implantable hearing prosthesis according to claim 1, wherein the acoustic transducer is adapted to float in an operating position without direct attachment to the tympanic membrane or skull bone of the patient.

4. An implantable hearing prosthesis according to claim 3, wherein the acoustic transducer floats at the end of a tethering lead.

5. An implantable hearing prosthesis according to claim 1, wherein the acoustic transducer is hermetically enclosed.

6. An implantable hearing prosthesis according to claim 1, wherein the acoustic transducer is enclosed by a biocompatible membrane.

7. An implantable hearing prosthesis according to claim 1, wherein the acoustic transducer is adapted to be fixedly attached to skull bone of the patient.

8. An implantable hearing prosthesis according to claim 1, wherein the acoustic transducer is adapted to be fixedly attached to the tympanic membrane.

9. An implantable hearing prosthesis according to claim 1, wherein the acoustic transducer produces a uni-directional acoustic signal.

10. An implantable hearing prosthesis according to claim 1, wherein the acoustic transducer produces a multi-directional acoustic signal.

11. An implantable hearing prosthesis according to claim 10, wherein the acoustic transducer produces a bi-directional acoustic signal.

12. An implantable hearing prosthesis according to claim 1, wherein the acoustic transducer has a flexible body for generating the acoustic signal.

13. An implantable hearing prosthesis according to claim 1, wherein the hearing structures include the oval window membrane of the patient.

14. An implantable hearing prosthesis according to claim 1, wherein the hearing structures include the round window membrane of the patient.

15. An implantable hearing prosthesis according to claim 1, wherein the hearing structures include one or more ossicles in the middle ear of the patient.

16. An implantable hearing prosthesis for a recipient patient, the prosthesis comprising:
an implantable receiving coil for receiving an externally generated communication data signal;
an implantable signal processor in communication with the receiving coil for converting the communication data signal into a transducer stimulation signal;
an implantable acoustic transducer in communication with the signal processor for converting the transducer stimulation signal into an acoustic vibrational stimulation signal; and
an implantable signal delivery baffle enclosing the acoustic transducer and mechanically coupling the acoustic vibrational stimulation signal to one or more hearing structures in the middle ear of the patient.

17. The implantable hearing prosthesis according to claim 16, wherein the acoustic transducer is a floating mass transducer.

18. The implantable hearing prosthesis according to claim 16, wherein the baffle is made of silicone.

19. The implantable hearing prosthesis according to claim 16, wherein the baffle is made of titanium.

20. The implantable hearing prosthesis according to claim 16, wherein the baffle is an open-ended cylinder.

21. The implantable hearing prosthesis according to claim 20, wherein the baffle's wall includes a plurality of folds aligned as ribs along the longitudinal axis of the cylinder.

22. The implantable hearing prosthesis according to claim 20, wherein the baffle's wall includes a plurality of folds aligned as ribs twisted about the longitudinal axis of the cylinder.

23. The implantable hearing prosthesis according to claim 20, wherein the baffle's wall includes a plurality of folds aligned perpendicular to the longitudinal axis of the cylinder.

24. The implantable hearing prosthesis according to claim 16, wherein the hearing structures include the oval window membrane of the patient.

25. The implantable hearing prosthesis according to claim 16, wherein the hearing structures include the round window membrane of the patient.

26. The implantable hearing prosthesis according to claim 16, wherein the hearing structures include one or more ossicles in the middle ear of the patient.

27. A probe microphone system for monitoring the middle ear of a patient comprising:
a microphone baffle adapted to enclose a volume of the middle ear;
a microphone tube operatively coupled to the baffle at a first end; and
a microphone operatively coupled to the second end of the microphone tube

28. The probe microphone system according to claim 27, further including a transducer coupled to the ear.

29. The probe microphone system according to claim 28, wherein the transducer is a floating mass transducer.

30. The probe microphone system according to claim 27, wherein the baffle is adapted to cover the entire middle ear.

31. The probe microphone system according to claim 27, wherein the baffle comprises medical grade silicone.
